(19) United States
(12) Patent Application Publication
(10) Pub. No.: US 2019/0102223 A1
(43) Pub. Date: Apr. 4, 2019

(54) System, Apparatus And Method For Real-Time Activated Scheduling In A Queue Management Device

(71) Applicants: Niall Power, Tramore (IE); Sean Harte, Limerick (IE); Niall D. McDonnell, Limerick (IE); Andrew Cunningham, Ennis (IE)

(72) Inventors: Niall Power, Tramore (IE); Sean Harte, Limerick (IE); Niall D. McDonnell, Limerick (IE); Andrew Cunningham, Ennis (IE)

(21) Appl. No.: 15/719,769

(22) Filed: Sep. 29, 2017

(51) Int. Cl. G06F 9/48

(52) U.S. Cl. CPC G06F 9/4887

(57) ABSTRACT

In one embodiment, a hardware queue manager is to receive tasks from a plurality of producer threads and allocate the tasks to a plurality of consumer threads. The hardware queue manager may include: a plurality of input queues each associated with one of the plurality of producer threads, each of the plurality of input queues having a plurality of entries to store a queue element associated with a task, the queue element including a task portion and timing information associated with the task; and an arbiter to select a consumer thread of the plurality of consumer threads to receive a task and select the task from a plurality of tasks stored in the plurality of input queues, based at least in part on the timing information of the queue element associated with the task. Other embodiments are described and claimed.

### TECHNICAL FIELD

Embodiments relate to task scheduling in a processor.

### BACKGROUND

In a multicore processor, a scheduler is used to schedule tasks for execution on particular cores. More specifically, some schedulers operate at thread level to schedule tasks for execution on particular threads. Applications such as baseband processing in wireless access networks have strict deadlines for processing latencies. Such deadlines complicate task scheduling, as later deadlines should not delay tasks having earlier deadlines. And a task that cannot make its deadline can still consume processing resources, which can adversely affect performance of both scheduler and cores on which threads execute. This is the case, as the scheduler seeks to schedule tasks based on deadline, and a core typically first checks to see whether a received task can be completed within the deadline.

### BRIEF DESCRIPTION OF THE DRAWINGS

FIG. 1 is a block diagram of a thread-based architecture in accordance with an embodiment.

FIG. 2 is a block diagram of a hardware queue manager in accordance with an embodiment of the present invention.

FIG. 3 is a scheduling example in accordance with an embodiment.

FIG. 4 is a flow diagram of a method in accordance with an embodiment of the present invention.

FIG. 5 is a timing diagram illustrating a clock synchronization technique in accordance with an embodiment of the present invention.

FIG. 6 is a block diagram of an example system with which embodiments can be used.

FIG. 7 is a block diagram of a system in accordance with another embodiment of the present invention.

FIG. 8 is a block diagram of a system in accordance with another embodiment of the present invention.

### DETAILED DESCRIPTION

In embodiments, a hardware queue manager (HQM) of a general-purpose multicore processor may at least partially handle a scheduling decision, resulting in increased throughput, decreased latency, and simpler software handling. In particular, the HQM may leverage timing information associated with tasks of multiple threads to make appropriate scheduling decisions. Using this timing information, which may include delay-based information and/or deadline-based information, the HQM can identify a task and provide it to a consumer thread when it is ready for execution.

Instead, when a given task is not yet ready for execution based on its timing information, the HQM prevents queueing information associated with that task from being accessible to a consumer thread (and the core on which such consumer thread executes). That is, as described herein with the delay/deadline-based information, a given input queue having queue information associated with tasks from a given provider thread can be blocked from further consideration in scheduling decisions until the delay has completed and/or the deadline is imminent. Although the scope of the present invention is not limited in this regard, embodiments may be used for wireless physical circuit (PHY) processing, in which tasks are to be executed at specific times. A HQM may distribute PHY workloads to multiple cores of a multicore processor. Of course, the real-time scheduling described herein can be used for scheduling of other real-time threads. One particular implementation of a multicore processor including one or more HQMs as described herein is for a wireless base station to perform wireless processing and communication. In some cases, this base station may leverage one or more HQMs to perform real-time scheduling of tasks associated with network interface circuitry, communications with user equipment, analysis of wireless signaling (such as analysis of orthogonal frequency division multiplexing waveforms), and so forth.

More specifically, with the scheduling performed herein, the HQM does not provide a task to a core until the task is ready to be processed. In contrast, typical schedulers push a task to a core even if the task is not due to be processed. Thus without an embodiment, a core is impacted by additional processing to accommodate scheduling. Stated another way, with a conventional scheduler that pushes tasks to cores prior to the time they are to execute, software that executes on the core de-queues a task from a scheduling queue and compares a current time against the time the task is due to be processed (namely a start time for the task). If the task is not due to be processed yet, additional overhead is consumed for the software to store the task on a separate software queue and wait for the appropriate time before the task can be executed (and further incurs additional compute overhead to identify this appropriate time).

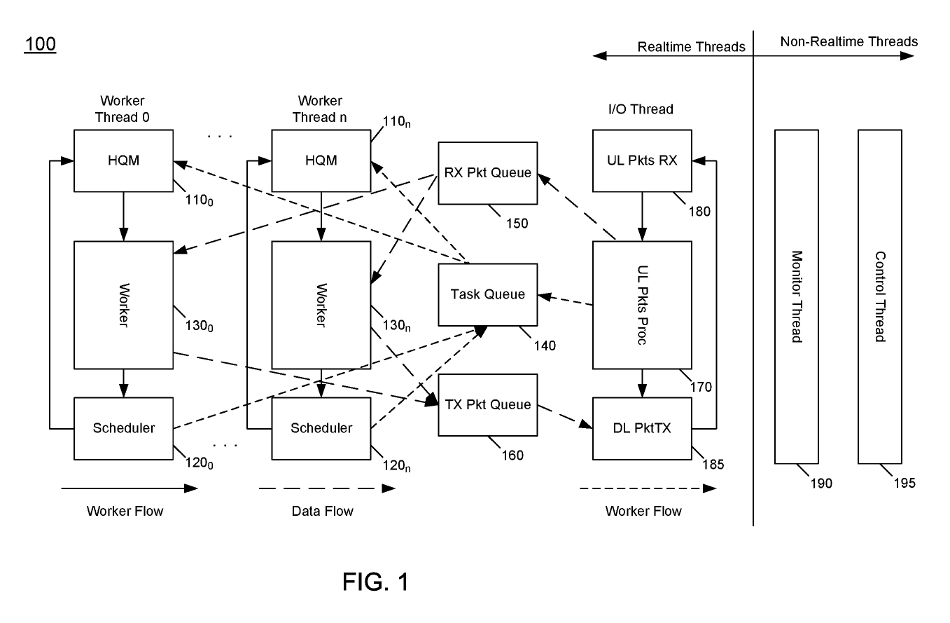

Referring now to FIG. 1, shown is a block diagram of a thread-based architecture in accordance with an embodiment. As illustrated in FIG. 1, architecture 100 includes a depiction of multiple threads, including both real-time threads and non-real-time threads. With embodiments as described herein, such real-time threads may be scheduled in real-time using one or more of a plurality of HQMs 110₀₋ₙ. In embodiments, HQM 110 (generically) may be implemented by hardware within a given processing engine such as a core or other hardware circuit coupled to one or more cores or other processing engines. That is in different embodiments, HQM 110 may be implemented as a standalone hardware circuit, e.g., part of so-called uncore circuitry separate from one or more cores of a processor. In other cases, HQM 110 may be implemented on a dedicated processor core. In still other embodiments, HQM 110 may be implemented as a dedicated microcontroller or other programmable control circuit to perform scheduling that leverages timing information as described herein.

Understand that in some embodiments as in FIG. 1, multiple HQMs 110 may be present in a given processor. For example, in a many-core multicore processor, a given HQM can be associated with multiple cores to provide tasks to the associated cores. As one simple example, there may be four HQMs within a 64-core processor. In this example, each HQM may be associated with 16 cores to provide tasks to consuming threads that execute on this set of 16 cores. In one embodiment, such HQMs may be implemented within an integrated device (such as a Peripheral Component Interconnect device) included in a processor. In yet other cases, the HQMs may be implemented within another device, such as a separate device, coupled to a general-purpose processor.

As further described herein, HQM 110 may include or be associated with an input queue structure and an output queue structure. The input queue structure may be used to store incoming tasks received from one or more schedulers. HQM 110 further may include arbitration circuitry or other selection logic to identify a given consumer thread and task for distribution to this thread. In turn, queue information associated with the selected task may be provided to an output queue of the output queue structure associated with the selected consumer thread.

HQM 110 may receive scheduled tasks, e.g., from multiple schedulers 120₀-120ₙ, each associated with a given one of multiple worker threads 130₀-130ₙ. Stated another way, HQM 110 supports multiple producers to multiple consumer scheduling via lockless queues. As such, each scheduler 120 may be load balanced across multiple consumers, such as worker threads, described below.

As seen, scheduler 120 (generically) provides scheduled tasks to HQM 110. More specifically as described herein, scheduler 120 may provide timing information associated with tasks to be accessed. HQM 110 uses this timing information in identifying tasks ready to be executed based on this timing information. Different timing information may be available, including delay information and/or deadline information. Based on at least some of this timing information, HQM 110 may place a corresponding task into a de-queuing or output queue structure populated by HQM 110 for access by a worker thread 130₀-130ₙ.

HQM 110 may populate the output queue structure (also referred to herein as a consumer queue) by loading task information into a selected output queue of the output queue structure. While logically included in HQM 110 in the illustration of FIG. 1 this queue structure may actually be implemented within a cache memory or other storage accessible to worker or consumer threads 130. In embodiments, each consumer thread 130 may be associated with a separate de-queuing or output queue of the output queue structure such that each worker 130 accesses a corresponding queue, polling for tasks according to, e.g., a first-in first-out configuration such that a top entry of the queue is accessed.

Depending upon the task identified in an entry within this consumer queue, workers 130 may obtain needed information for processing the task, such as incoming packet information, from a receiver packet queue 150. In turn, assuming that the task is associated with a transmit operation, a result of the processing, e.g., a generated packet, may be provided from workers 130 to a transmit packet queue 160.

As further illustrated in FIG. 1, another real-time thread may be an input/output (I/O) thread that interfaces with queues 140, 150 and 160. To this end, an uplink (UL) packet processor 170 may provide incoming packets as received from an uplink packet receiver 180 to receiver packet queue 150. And in turn UL packet processor 170 may further couple to a downlink (DL) packet transmitter 185 that receives packets from transmit packet queue 160.

As further illustrated in FIG. 1, additional threads may be provided in a given thread architecture, including non-real-time threads such as a monitor thread 190 and a control thread 195. Note however that these non-real-time threads are not scheduled using a scheduling mechanism and HQM as described herein.

In embodiments, HQM 110 performs a time synchronized de-queue into the de-queuing structure. In this way, software can schedule tasks in the future at flexible high granularity timing intervals, and HQM 110 enables a de-queue of a task only after the timer associated with the task has expired. If the timer has not expired when a given consumer queue is polled, an entity (e.g., software executing on a core) receives a null, reducing complexity in scheduling overhead and timestamp comparisons. HQM 110 thus performs real-time scheduling of work.

After selection of a consumer, HQM 110 selects the appropriate input queue of the input queue structure for that consumer, pops the head of the input queue, and writes the result to a corresponding consumer queue, assuming that the timing information associated with the queue element indicates that it is ready for scheduling. Data plane software threads operate to pull queue information from an associated consumer queue and/or enqueue queue information to a producer port, specifying the selected input queue as part of the enqueuing process.

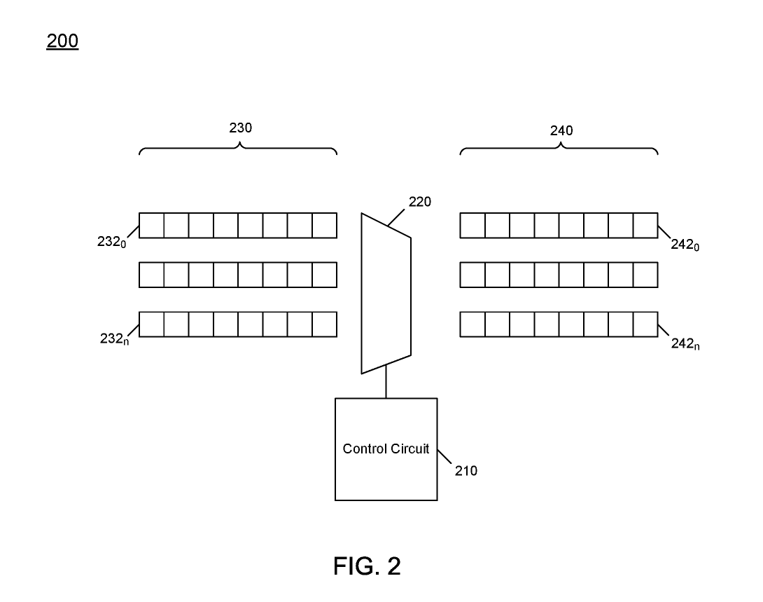

Referring now to FIG. 2, shown is a block diagram of a hardware queue manager in accordance with an embodiment of the present invention. HQM 200 is shown at a high level in FIG. 2 to illustrate a typical configuration of an HQM to perform real-time scheduling of work. As illustrated, HQM 200 includes a control circuit 210 that may be implemented as hardware circuitry, software, firmware and/or combinations thereof, such as a finite state machine and/or microcode to execute on a programmable control circuit such as a microcontroller or other processing engine. In turn, control circuit 210 interacts with an arbiter 220 that performs arbitration between different incoming tasks that are stored in an input queue structure 230, referred to herein as an HQM queue internal structure (HQM queue identifier QID). Note that the number of queues in HQM 200 represents an aggregation of queues having different priorities.

As illustrated, queue structure 230 may be implemented as a plurality of independent queues 232₀-232ₙ. In embodiments, queues 232 may be implemented as variable length internal queues of HQM 200. Each queue 232 may be associated with a particular producer thread and may include a plurality of entries, each to store information for an associated scheduled task that is provided to HQM 200 by a scheduler and/or a producer thread. As will be described further herein, each entry within a given queue 232 may store a queue element (QE) that includes various information regarding a given task. In an embodiment, this QE may include various identifying information to enable a thread to obtain needed information such as a pointer to the task (e.g., a location of instruction code of the task, packet, function, etc.) source data, destination information and so forth. Still further as described herein, the queue element includes timing information, details of which are described below.

In an embodiment, arbiter 220 may be configured to perform an arbitration by selecting a given consumer (e.g., each corresponding to a particular consumer thread). Although the scope of the present invention is not limited in this regard, in an embodiment the arbitration may be based on consumer readiness (e.g., having space available for a task), task availability. Thereafter, a round robin arbitration may be performed on queues meeting these (and any other) criteria. Thereafter, arbiter 220 selects a task from a corresponding queue 232 to provide to the consumer by way of placing the selected task into a given entry of a corresponding output or consumer queue structure 240. More specifically as shown in FIG. 2, consumer queue structure 240 may be implemented as a plurality of independent queues 242₀-242ₙ. In embodiments, queues 242 may be implemented as variable length queues, which in some embodiments, may be implemented within a shared cache memory accessible by a plurality of consumer threads. Each queue 242 may be associated with a particular consumer thread and may include a plurality of entries, each to store information for an associated task that is selected by HQM 200. Understand while shown at this high level in the embodiment of FIG. 2, many variations and alternatives are possible. As an example, while a representative embodiment may dedicate QIDs and consumer queue structures with a particular producer and consumer, respectively, in other cases each of the queues may be associated with multiple threads. That is, it is possible for a producer to enqueue to more than one QID and for a consumer to pull/dequeue from more than one consumer queue.

In one embodiment, each QE is 16 bytes (B) in size, typically containing an 8B pointer to the task and other data. Referring now to Table 1, shown is an example queue element format in accordance with an embodiment. In a particular embodiment, timing information in the queue element includes both delay and deadline-based information.

TABLE 1

| Bits | N | 1 | 31 | 1 | 31 |
|---|---|---|---|---|---|
| Description | Other | Delay | Delay | Deadline | Deadline |
| | Fields | timestamp | timestamp | timestamp | timestamp |
| | | valid | | valid | |

When a queue element having a timing flag that indicates that the QE is for a real-time task (in Table 1 either or both of the valid fields, delay and deadline timestamps valid in Table 2) is popped from the head of an QID, a real-time flag identifies it as such. The QE is written to the consumer queue to ensure correct crediting, and so forth. As an option, a history list entry may be created, which is maintained until the consumer returns a completion.

In an embodiment having a single clock reference included in a QE (e.g., a delay timestamp), the arbiter is configured to not schedule any further QEs from that input queue (and therefore any following traffic) until the device time of the HQM is greater than or equal to the delay timestamp. As such, the HQM does not pull the top entry or any other task from this input queue until this delay has expired. Stated another way, even though the QID has work in its queues, it is essentially masked from the arbitration until the delay timestamp is met. A given QE is thus pulled from an input queue when the delay for that QE has expired and the HQM schedules the task.

In an embodiment with two clock references included in a QE (e.g., delay and deadline timestamps), the HQM is configured for different operation. Specifically, the HQM handles the delay timestamp as above. As to the deadline clock reference, it may be stored per producer queue. Every time the arbiter of the HQM considers that input queue for scheduling, it compares that queue's deadline clock reference with the current time. If the current time is greater than the deadline time, all queue elements are marked as late until a next queue element of the QID having a deadline clock reference is reached. In an embodiment, marking a QE as late includes setting a flag in the consumed QE to indicate that the task is now late (not shown in Table 1 for ease of illustration). Software may determine to treat late packets as it sees fit, including dropping them, such that no further action is taken with regard to the task associated with these QEs. Note that in this instance of a late packet, the HQM still de-queues the QE into a consumer queue to be pulled by a worker. In this regard the HQM operates to provide descriptors to tasks. To drop a late task, software may be configured to deallocate associated memory with the task, and take any action to notify the system of the drop. Stated another way, the HQM is configured to not drop late QEs, but instead only mark them as late, to enable software to make drop decisions.

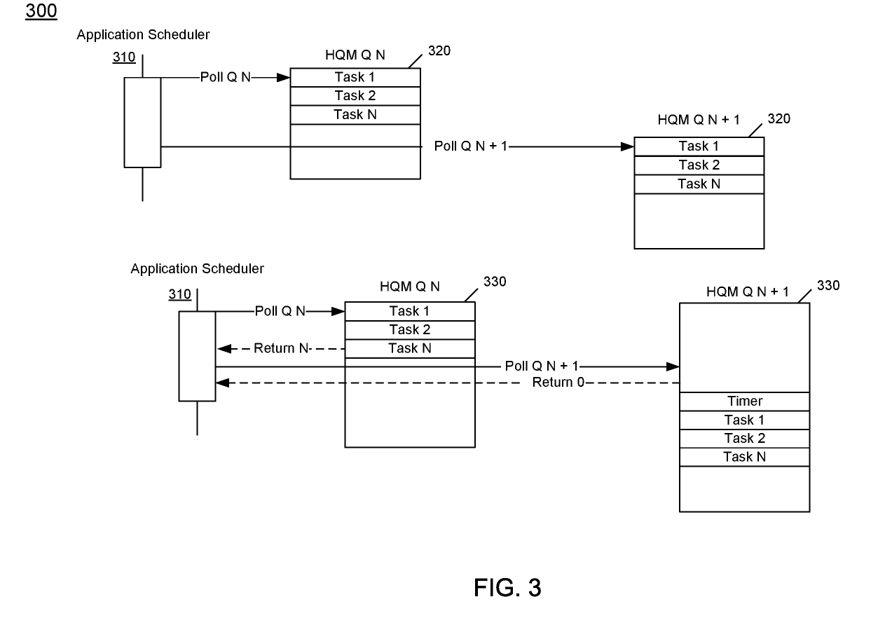

Referring now to FIG. 3, shown is a scheduling example in accordance with an embodiment. As shown in illustration 300, an application scheduler 310 performs scheduling decisions based on information stored in consumer queues, namely consumer queues 320, 330 associated with an HQM. As illustrated, application scheduler 310 initially polls first queue 320 for a task N. In turn, this task N is returned, as it was present within first queue 320. Assume that the queue elements stored in first queue 320 do not have timing information as described herein. In this instance, there is no masking of tasks in the absence of timing information, and as such application scheduler 310 may schedule the task to execute as soon as possible.

Instead, assume that timing information in accordance with an embodiment is stored within the queue elements within second queue 330. In this case, when scheduler 310 polls second queue 330 at a time prior to expiration of a delay period identified within the timing information for a top entry, second queue 330 appears empty, since the time until the delay completion has not yet expired. Stated another way, a task is masked from application scheduler 310 until the delay period expires. As such, a null value is returned, and scheduler 310 need not perform any determination as to whether a task is ready to execute. Rather, when the time expires and the task becomes visible within second queue 330, application scheduler 310 may de-queue the task and identify it as ready for execution. Note that, in some embodiments, the HQM may schedule tasks (by insertion into a given consumer queue), with some delay before a deadline so the consumer has ample time to process the request. Note that a consumer may regularly poll one or more consumer queues. In an embodiment, a consumer thread may poll to determine if the HQM has sent any new tasks for processing by placement of a monitor on a cache line that HQM is writing to next.

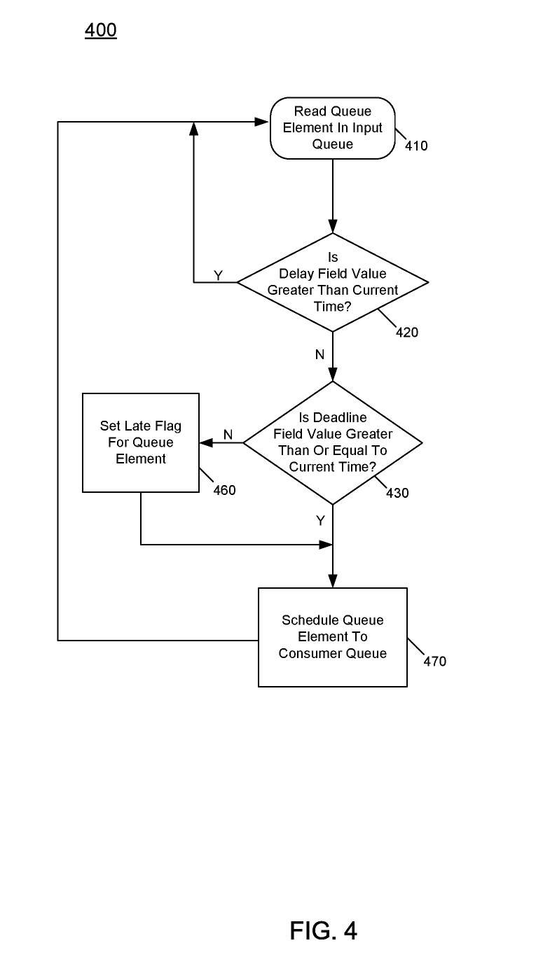

Referring now to FIG. 4, shown is a flow diagram of a method in accordance with an embodiment of the present invention. As shown in FIG. 4, method 400 may be performed by an arbiter of an HQM as described herein. As such, method 400 may be performed by hardware circuitry, software, firmware and/or combinations thereof. As illustrated, method 400 begins by reading a queue element (QE) of a given input queue of the HQM (e.g., associated with a particular producer thread) (block 410). Next, it is determined at diamond 420 whether a value stored in a delay field of the queue element exceeds a current time. This determination may be based on comparison of the delay field value with a timestamp counter of the HQM, which maintains the current time.

If it is determined that the value stored in the delay field is greater than the current time, this means that the task associated with this queue element is not yet to be scheduled, as it is not ready for scheduling. If the delay field value indicates that task execution is in the future (namely exceeding the current time), control passes back to block 410, where another queue element may be read. More specifically, this queue element may be the queue element at a head of a different producer queue. That is, if the queue element at the head of a queue associated with a given producer thread is not ready for scheduling, then no element of that queue behind this top of queue element is handled until the queue element at the head is selected.

Still with reference to FIG. 4, if it is determined that value of the delay field does not exceed the current time, this means that the task associated with this queue element is ready for scheduling. As such, control passes to diamond 430 where it is determined whether the task associated with the queue element is late. As seen, this determination is as to whether a deadline value equals or is greater than the current time. If not, that means this task is past due and as such, control passes to block 460 where an indicator or flag associated with the queue element may be set to indicate that the task is now late. In an embodiment, in addition to setting this late indicator, the deadline value itself may be cleared. Note that in cases where a queue element is updated with a late flag, one or more subsequent queue elements of this consumer queue may be deemed to be late, until a queue element is encountered that has a new deadline value. Although the scope of the present invention is not limited in this regard, in an embodiment this late task may be sent to software to perform a cleanup operation with respect to the task. As an example, the task may be placed into a consumer queue with a set late flag, to enable software to drop the task, as control passes to block 470, described below.

Still with reference to FIG. 4, if it is determined that the deadline has not yet passed, control passes from diamond 430 to block 470 where the task may be scheduled to a consumer queue. More specifically, the arbiter may schedule this task by writing information of this queue element into a given one of multiple consumer queues. In an embodiment, all information in the queue element (as provided by a producer) may be written into the consumer queue along with any information added by the HQM such as a late flag. Understand that after this writing, a consumer thread associated with that queue may read the queue element information and perform the task associated with that queue element. More particularly, by using an embodiment this entry becomes visible to consumer thread only when it is ready to be executed. Although shown at this high level in the embodiment of FIG. 4, many variations and alternatives are possible.

In an embodiment, the HQM may use a timer that is implemented as a free running counter, creating the notion of “device time.” Software on cores and the arbiter within the HQM are able to synchronize clocks so that clock references provided by one can be understood by the other, as described further below.

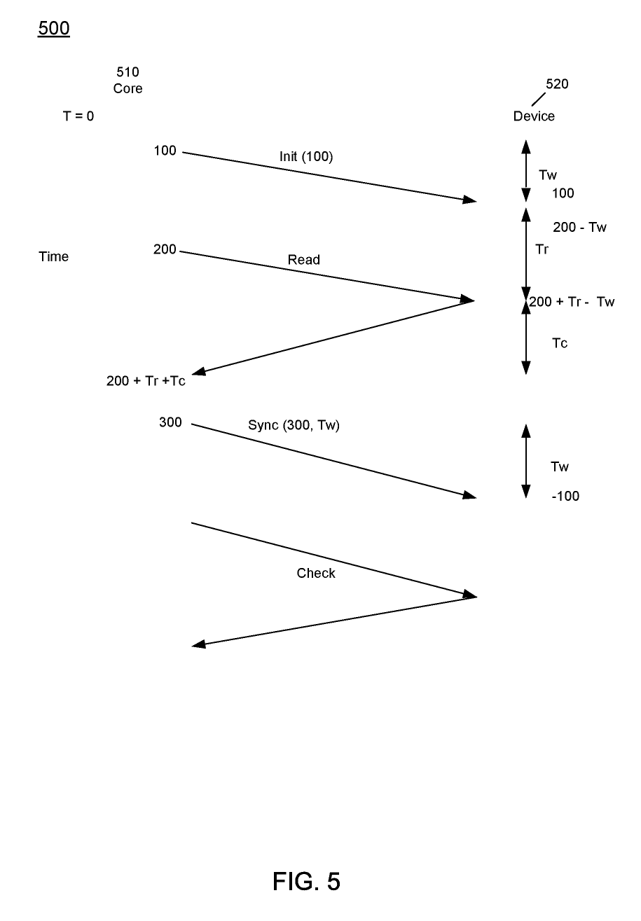

This clock synchronization may be done by a physical function driver, such as a software entity that controls the HQM on boot, interleaving with actual traffic. Referring now to FIG. 5, shown is a timing diagram illustrating a clock synchronization technique in accordance with an embodiment of the present invention. As seen in FIG. 5, a core 510 is coupled to a device 520, namely the HQM. Note that core 510 may execute one or more consumers, producers, or both. In general, this time synchronization, which is initiated by core 510, is used to identify a timing mismatch between core 510 and device 520 that is recognized by both entities, such that the base time maintained by core 510 (e.g., as implemented using a current time identified by a time stamp counter (TSC)) is recognized by device 520.

In FIG. 5, the following timing values are used: Tw=time for a write to propagate to device 520; Tr=time for a read to propagate to device 520; and Tc=time for read data to return from device 520 to core 510. Understand that while these times may vary somewhat, synchronization may not occur if they are random. As seen, at initialization (e.g., at a TSC value of 100) core 510 issues an initialization write command (INIT Write) with this TSC value to device 520. In response to this message, device 520 initializes its counter to the value written. Note that in different implementations, device 520 may have access to the TSC of core 510, or it may have an internal counter, synchronized to the core TSC. The gap between the counters in core 510 and device 520 is now reflective of Tw, the write time. Note further that device 520 has a dTw value, which is initialized to a predetermined value (e.g., 0) in response to the INIT Write command. Next on a read operation, core 510 reads the device timer and compares it with the TSC value. The difference between these two values is assumed to be equal to Tw+Tc. As such, core 510 assumes Tw substantially equals Tc, and hence evaluates Tw.

During operation a synchronization may occur. In one embodiment, this synchronization is initiated when core 510 writes a current time with a synchronization (Sync) command, and its estimate for Tw (Sync (300, Tw) in FIG. 5). In response to this synchronization command, device 520 now estimates Tw, namely core time—device time. In turn, the difference between the estimates is the Tw variance (between the time of Sync and Init). This variance may be stored as dTw within device 520.

Note that repeated reads will provide initial Tw estimates. In turn, repeated Sync/Checks, essentially reads of the dTw value, will provide repeated dTw estimates (relative to the initial Tw), meaning that there are repeated estimates of the write delay. In embodiments, software can restart with INIT as it determines is appropriate. As an example, software may perform this operation periodically (e.g., once per hour) to ensure normal operation. Note it is possible to allow a build up of the expected range for this value and discard anomalies. Understand while shown with this particular implementation in FIG. 5, many variations and alternatives are possible.

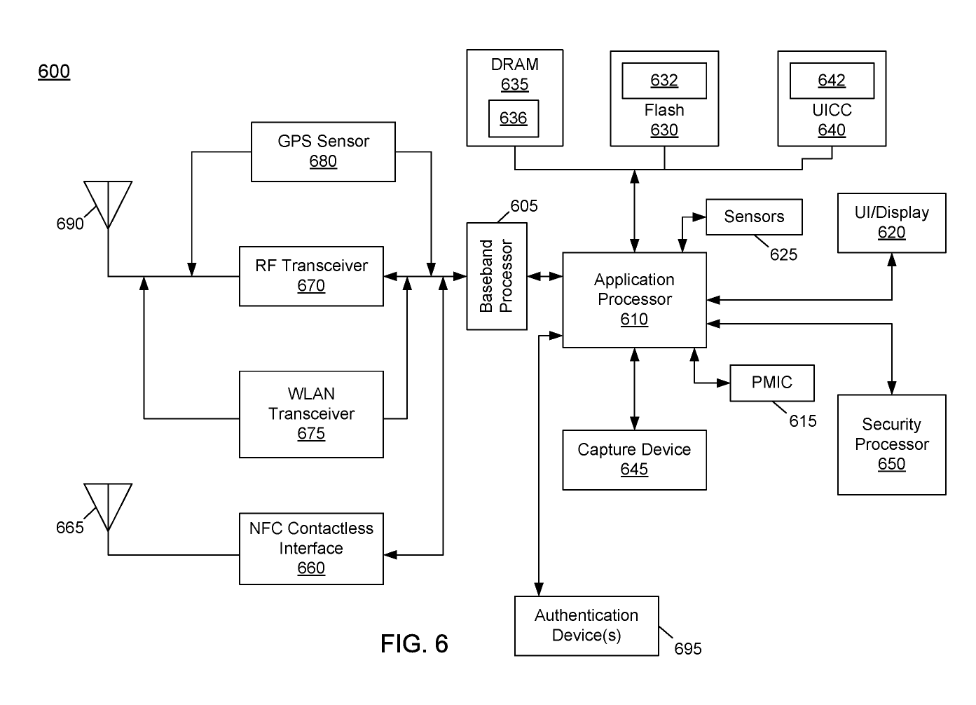

Referring now to FIG. 6, shown is a block diagram of an example system with which embodiments can be used. As seen, system 600 may be a smartphone or other wireless communicator or any other Internet of Things (IoT) device. A baseband processor 605 is configured to perform various signal processing with regard to communication signals to be transmitted from or received by the system. In turn, baseband processor 605 is coupled to an application processor 610, which may be a main CPU of the system to execute an OS and other system software, in addition to user applications such as many well-known social media and multimedia apps. Application processor 610 may further be configured to perform a variety of other computing operations for the device.

In turn, application processor 610 can couple to a user interface/display 620, e.g., a touch screen display. In addition, application processor 610 may couple to a memory system including a non-volatile memory, namely a flash memory 630 and a system memory, namely a DRAM 635. In different embodiments, application processor 610 may include a hardware queue manager to perform real-time scheduling of threads as described herein. In some embodiments, flash memory 630 and/or DRAM 635 may include a secure portion 632/636 in which secrets and other sensitive information may be stored. As further seen, application processor 610 also couples to a capture device 645 such as one or more image capture devices that can record video and/or still images.

Still referring to FIG. 6, a universal integrated circuit card (UICC) 640 comprises a subscriber identity module, which in some embodiments includes a secure storage 642 to store secure user information. System 600 may further include a security processor 650 that may implement a trusted execution environment, and which may couple to application processor 610. A plurality of sensors 625, including one or more multi-axis accelerometers may couple to application processor 610 to enable input of a variety of sensed information such as motion and other environmental information. In addition, one or more authentication devices 695 may be used to receive, e.g., user biometric input for use in authentication operations.

As further illustrated, a near field communication (NFC) contactless interface 660 is provided that communicates in a NFC near field via an NFC antenna 665. While separate antennae are shown in FIG. 6, understand that in some implementations one antenna or a different set of antennae may be provided to enable various wireless functionality.

A power management integrated circuit (PMIC) 615 couples to application processor 610 to perform platform level power management. To this end, PMIC 615 may issue power management requests to application processor 610 to enter certain low power states as desired. Furthermore, based on platform constraints, PMIC 615 may also control the power level of other components of system 600.

To enable communications to be transmitted and received such as in one or more wireless networks, various circuitry may be coupled between baseband processor 605 and an antenna 690. Specifically, a radio frequency (RF) transceiver 670 and a wireless local area network (WLAN) transceiver 675 may be present. In general, RF transceiver 670 may be used to receive and transmit wireless data and calls according to a given wireless communication protocol such as 4G or 5G wireless communication protocol such as in accordance with a code division multiple access (CDMA), global system for mobile communication (GSM), long term evolution (LTE) or other protocol. In addition a GPS sensor 680 may be present. Other wireless communications such as receipt or transmission of radio signals, e.g., AM/FM and other signals may also be provided. In addition, via WLAN transceiver 675, local wireless communications, such as according to a Bluetooth™ or IEEE 802.11 standard can also be realized.

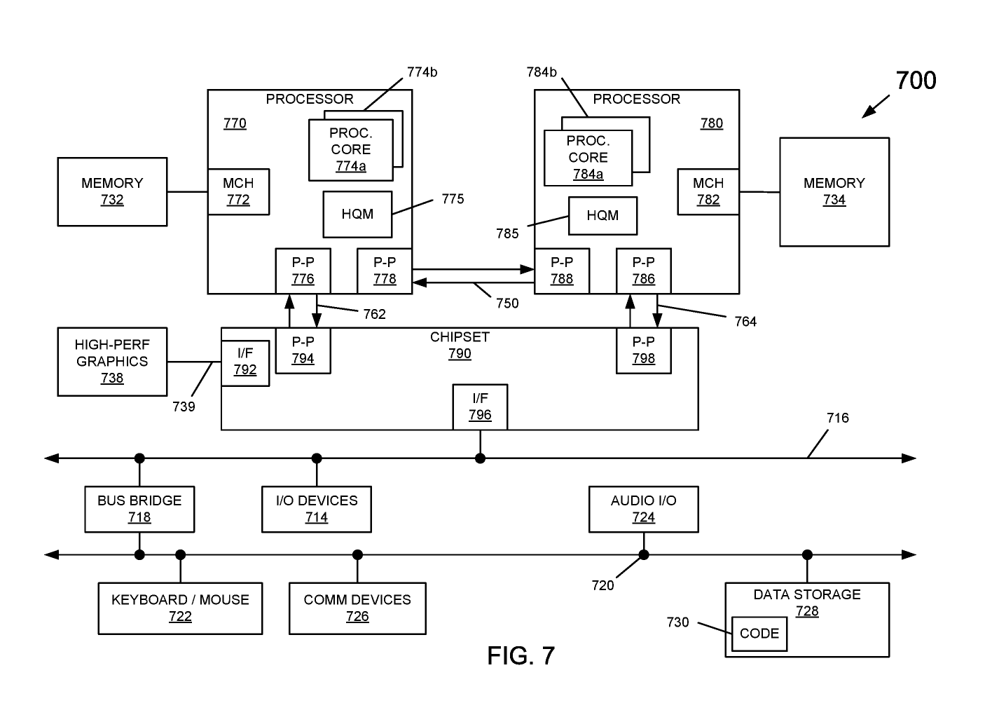

Referring now to FIG. 7, shown is a block diagram of a system in accordance with another embodiment of the present invention. As shown in FIG. 7, multiprocessor system 700 is a point-to-point interconnect system such as a server system, and includes a first processor 770 and a second processor 780 coupled via a point-to-point interconnect 750. As shown in FIG. 5, each of processors 770 and 780 may be multicore processors such as SoCs, including first and second processor cores (i.e., processor cores 774a and 774b and processor cores 784a and 784b), although potentially many more cores may be present in the processors. In addition, processors 770 and 780 each may include a hardware queue manager 775 or 785 to perform real-time thread scheduling for one or more groups of cores, as described herein.

Still referring to FIG. 7, first processor 770 further includes a memory controller hub (MCH) 772 and point-to-point (P-P) interfaces 776 and 778. Similarly, second processor 780 includes a MCH 782 and P-P interfaces 786 and 788. As shown in FIG. 7, MCH's 772 and 782 couple the processors to respective memories, namely a memory 732 and a memory 734, which may be portions of main memory (e.g., a DRAM) locally attached to the respective processors. First processor 770 and second processor 780 may be coupled to a chipset 790 via P-P interconnects 752 and 754, respectively. As shown in FIG. 7, chipset 790 includes P-P interfaces 794 and 798.

Furthermore, chipset 790 includes an interface 792 to couple chipset 790 with a high performance graphics engine 738, by a P-P interconnect 739. In turn, chipset 790 may be coupled to a first bus 716 via an interface 796. As shown in FIG. 7, various input/output (I/O) devices 714 may be coupled to first bus 716, along with a bus bridge 718 which couples first bus 716 to a second bus 720. Various devices may be coupled to second bus 720 including, for example, a keyboard/mouse 722, communication devices 726 and a data storage unit 728 such as a non-volatile storage or other mass storage device. As seen, data storage unit 728 may include code 730, in one embodiment. Further, an audio I/O 724 may be coupled to second bus 720.

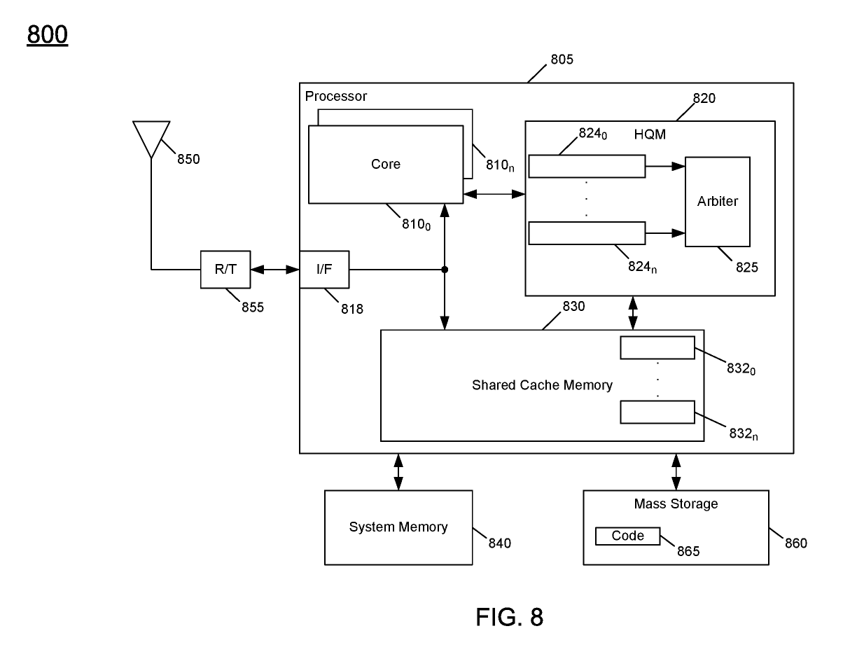

Referring now to FIG. 8, shown is a block diagram of a system in accordance with another embodiment of the present invention. As shown in FIG. 8, system 800 may be any type of computing system. In one particular example, system 800 may be a base station that performs real-time thread scheduling as described herein. As illustrated, system 800 includes a processor 805, such as a multicore processor or other type of SoC.

Processor 805 includes a plurality of cores 810₀-810ₙ. To effect scheduling of real-time threads, a HQM 820 is associated with cores 810. Understand that in other embodiments multiple HQMs may be included in a processor. In the embodiment shown in FIG. 8, HQM 820 includes a plurality of input queues 824₀-824ₙ. Each input queue 824 may be associated with one or more producer threads to receive incoming tasks and store them in the entries of the corresponding input queues 824. In turn, input queues 824 couple to an arbiter 825, which may perform arbitration as described herein. As such, arbiter 824 may select a task for execution based at least in part on timing information of the queue elements stored in the queue entries. In this manner, arbiter 825 may select a queue element for this selected task and store it in a corresponding entry of one of a plurality of output queues 832₀-832ₙ. As seen in the embodiment of FIG. 8, output queues 832 may be implemented within a shared cache memory 830. As such, output queues 832 may be accessible to threads that execute on cores 810. In an embodiment, each output queue 832 may be associated with one or more consumer threads that execute on cores 810.

As further shown in FIG. 8, processor 805 couples to a system memory 840 which, in an embodiment may be implemented as a dynamic random access memory (DRAM) or other memory type. In addition, system 800 includes a mass storage 860 (which in one embodiment may be implemented as a flash memory or other non-volatile storage) that includes code 865. Code 865 may be used to execute various base station or other operations within system 800. As illustrated, processor 805 further includes an interface 818 to enable coupling to other components of system 800. As shown, such components include a receiver/transmitter 855 that may receive and transmit packets via an antenna 850. Understand while shown at this high level in the embodiment of FIG. 8, many variations and alternatives are possible.

The following examples pertain to further embodiments.

In one example, an apparatus includes a hardware queue manager to receive tasks from a plurality of producer threads and allocate the tasks to a plurality of consumer threads. The hardware queue manager may comprise: a plurality of input queues each associated with one of the plurality of producer threads, each of the plurality of input queues having a plurality of entries to store a queue element associated with a task, the queue element including a task portion and timing information associated with the task; and an arbiter to select a consumer thread of the plurality of consumer threads to receive a task and select the task from a plurality of tasks stored in the plurality of input queues, based at least in part on the timing information of the queue element associated with the task.

In an example, the arbiter is to store the queue element of the task in a first consumer queue of a plurality of consumer queues, each of the plurality of consumer queues associated with one of the plurality of consumer threads.

In an example, the apparatus further comprises a shared cache memory comprising the plurality of consumer queues, the shared cache memory accessible to the plurality of consumer threads.

In an example, the timing information comprises one or more of deadline information and delay information.

In an example, the hardware queue manager further comprises a counter to maintain a current time, where the arbiter is to select the task from the plurality of tasks after the delay information exceeds the current time.

In an example, the arbiter is to not select any other task stored in the first consumer queue until the task is selected after the delay information exceeds the current time.

In an example, the task is to be visible to the consumer thread after the storage of the task in the first consumer queue, the first consumer queue associated with the consumer thread, where the task is not visible to the consumer thread prior to the storage in the first consumer queue.

In an example, prior to the storage of the task in the first consumer queue, the consumer thread is to receive a null value in response to a poll of the first consumer queue.

In an example, the queue element further comprises a timing flag having a first value to indicate that the queue element includes the timing information.

In an example, the apparatus comprises a processor having a plurality of cores, where the hardware queue manager is to provide the tasks to at least some of the plurality of cores.

In an example, the plurality of cores comprises N cores and the processor further comprises M hardware queue managers, where M is less than N.

In another example, a method comprises: identifying, in a hardware queue manager of a processor, a first consumer thread of a plurality of consumer threads; determining, based on first timing information stored in a first entry of a first input queue of a plurality of input queues, whether a first task associated with the first entry is ready to be scheduled to the first consumer thread; and in response to determining that the first task is ready to be scheduled, storing a first queue element from the first entry of the first input queue into a first consumer queue associated with the first consumer thread, to enable the first task to be visible to the first consumer thread.

In an example, the method further comprises in response to determining that the first task is not ready to be scheduled, preventing one or more additional tasks associated with one or more additional entries of the first input queue from becoming visible to the first consumer thread.

In an example, the method further comprises: identifying, based on second timing information stored in a second entry of the first input queue, that a deadline for handling a second task associated with the second entry has passed; and marking one or more additional entries of the first input queue following the second entry to indicate that tasks associated with the one or more additional entries are late.

In an example, the method further comprises synchronizing a first timer associated with the hardware queue manager with a second timer associated with a first core on which one or more of the plurality of consumer threads are to execute.

In another example, a computer readable medium including instructions is to perform the method of any of the above examples.

In another example, a computer readable medium including data is to be used by at least one machine to fabricate at least one integrated circuit to perform the method of any one of the above examples.

In another example, an apparatus comprises means for performing the method of any one of the above examples.

In yet another example, a system includes a processor having a plurality of cores, a shared cache memory coupled to the plurality of cores, and at least one hardware queue manager to receive tasks from a plurality of producer threads and allocate the tasks to a plurality of consumer threads to execute on at least some of the plurality of cores. The at least one hardware queue manager may comprise: a plurality of input queues each associated with at least one of the plurality of producer threads, each of the plurality of input queues having a plurality of entries to store a queue element associated with a task, the queue element including a task portion and timing information associated with the task; and an arbiter to select a task from a plurality of tasks stored in the plurality of input queues based at least in part on the timing information of the queue element associated with the task, and store the queue element associated with the task to one of a plurality of output queues each associated with at least one of the plurality of consumer threads, where the shared cache memory comprises the plurality of output queues. The system may further include a system memory coupled to the processor.

In an example, the timing information comprises deadline information, and the at least one hardware queue manager is to mark a first entry of a first input queue of the plurality of input queues with a late indicator in response to the selection of the task associated with the first input queue after a deadline identified in the deadline information of the queue element has passed.

In an example, the timing information comprises delay information, and the at least one hardware queue manager is to select a first task associated with a first entry of a first input queue of the plurality of input queues in response to a determination that a delay period identified in the delay information of the queue element has passed.

In an example, the system comprises a base station, and the at least one hardware queue manager is to schedule a plurality of real-time wireless tasks and mask a first real-time wireless task of the plurality of real-time wireless tasks from being accessible to the plurality of consumer threads, until a delay period identified within the timing information of the queue element associated with the first real-time wireless task has concluded.

In yet another example, an apparatus comprises: a plurality of input queue means each having a plurality of entry means for storing a queue element associated with a task, the queue element including a task portion and timing information associated with the task, each of the plurality of input queue means associated with at least one of a plurality of producer threads; and arbiter means for selecting a task from a plurality of tasks stored in the plurality of input queue means, based at least in part on the timing information of the queue element associated with the task.

In an example, the arbiter means is to store the queue element of the task in a first consumer queue means of a plurality of consumer queue means, each of the plurality of consumer queue means associated with at least one of a plurality of consumer threads.

In an example, the apparatus further comprises shared cache memory means comprising the plurality of consumer queue means, the shared cache memory means accessible to the plurality of consumer threads.

In an example, the apparatus further comprises: means for enabling the task to be visible to a first consumer thread after the storage of the task in the first consumer queue means; and means for preventing the task from being visible to the first consumer thread prior to the storage of the task in the first consumer queue means.

In an example, the apparatus further comprises means for maintaining a current time, wherein the arbiter means is to select the task from the plurality of tasks after delay information included in the timing information exceeds the current time.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a hardware queue manager to receive tasks from a plurality of producer threads and allocate the tasks to a plurality of consumer threads, the hardware queue manager comprising:
a plurality of input queues each associated with one of the plurality of producer threads, each of the plurality of input queues having a plurality of entries to store a queue element associated with a task, the queue element including a task portion and timing information associated with the task; and
an arbiter to select a consumer thread of the plurality of consumer threads to receive a task and select the task from a plurality of tasks stored in the plurality of input queues, based at least in part on the timing information of the queue element associated with the task.

2. The apparatus of claim 1, wherein the arbiter is to store the queue element of the task in a first consumer queue of a plurality of consumer queues, each of the plurality of consumer queues associated with one of the plurality of consumer threads.

3. The apparatus of claim 2, further comprising a shared cache memory comprising the plurality of consumer queues, the shared cache memory accessible to the plurality of consumer threads.

4. The apparatus of claim 2, wherein the timing information comprises deadline information.

5. The apparatus of claim 2, wherein the timing information comprises delay information.

6. The apparatus of claim 5, wherein the hardware queue manager further comprises a counter to maintain a current time, wherein the arbiter is to select the task from the plurality of tasks after the delay information exceeds the current time.

7. The apparatus of claim 6, wherein the arbiter is to not select any other task stored in the first consumer queue until the task is selected after the delay information exceeds the current time.

8. The apparatus of claim 5, wherein the task is to be visible to the consumer thread after the storage of the task in the first consumer queue, the first consumer queue associated with the consumer thread, wherein the task is not visible to the consumer thread prior to the storage in the first consumer queue.

9. The apparatus of claim 8, wherein prior to the storage of the task in the first consumer queue, the consumer thread is to receive a null value in response to a poll of the first consumer queue.

10. The apparatus of claim 2, wherein the queue element further comprises a timing flag having a first value to indicate that the queue element includes the timing information.

11. The apparatus of claim 1, wherein the apparatus comprises a processor having a plurality of cores, wherein the hardware queue manager is to provide the tasks to at least some of the plurality of cores.

12. The apparatus of claim 11, wherein the plurality of cores comprises N cores and the processor further comprises M hardware queue managers, wherein M is less than N.

13. A machine-readable medium having stored thereon instructions, which if performed by a machine cause the machine to perform a method comprising:
identifying, in a hardware queue manager of a processor, a first consumer thread of a plurality of consumer threads;
determining, based on first timing information stored in a first entry of a first input queue of a plurality of input queues, whether a first task associated with the first entry is ready to be scheduled to the first consumer thread; and
in response to determining that the first task is ready to be scheduled, storing a first queue element from the first entry of the first input queue into a first consumer queue associated with the first consumer thread, to enable the first task to be visible to the first consumer thread.

14. The machine-readable medium of claim 13, wherein the method further comprises in response to determining that the first task is not ready to be scheduled, preventing one or more additional tasks associated with one or more additional entries of the first input queue from becoming visible to the first consumer thread.

15. The machine-readable medium of claim 13, wherein the method further comprises:
identifying, based on second timing information stored in a second entry of the first input queue, that a deadline for handling a second task associated with the second entry has passed; and
marking one or more additional entries of the first input queue following the second entry to indicate that tasks associated with the one or more additional entries are late.

16. The machine-readable medium of claim 13, wherein the method further comprises synchronizing a first timer associated with the hardware queue manager with a second timer associated with a first core on which one or more of the plurality of consumer threads are to execute.

17. A system comprising:
a processor including a plurality of cores, a shared cache memory coupled to the plurality of cores, and at least one hardware queue manager to receive tasks from a plurality of producer threads and allocate the tasks to a plurality of consumer threads to execute on at least some of the plurality of cores, the at least one hardware queue manager comprising:
a plurality of input queues each associated with at least one of the plurality of producer threads, each of the plurality of input queues having a plurality of entries to store a queue element associated with a task, the queue element including a task portion and timing information associated with the task; and
an arbiter to select a task from a plurality of tasks stored in the plurality of input queues based at least in part on the timing information of the queue element associated with the task, and store the queue element associated with the task to one of a plurality of output queues each associated with at least one of the plurality of consumer threads, wherein the shared cache memory comprises the plurality of output queues; and
a system memory coupled to the processor.

18. The system of claim 17, wherein the timing information comprises deadline information, and the at least one hardware queue manager is to mark a first entry of a first input queue of the plurality of input queues with a late indicator in response to the selection of the task associated with the first input queue after a deadline identified in the deadline information of the queue element has passed.

19. The system of claim 17, wherein the timing information comprises delay information, and the at least one hardware queue manager is to select a first task associated with a first entry of a first input queue of the plurality of input queues in response to a determination that a delay period identified in the delay information of the queue element has passed.

20. The system of claim 17, wherein the system comprises a base station, and the at least one hardware queue manager is to schedule a plurality of real-time wireless tasks and mask a first real-time wireless task of the plurality of real-time wireless tasks from being accessible to the plurality of consumer threads, until a delay period identified within the timing information of the queue element associated with the first real-time wireless task has concluded.
